(19) United States
(12) Patent Application Publication
(10) Pub. No.: US 2021/0369557 A1
(43) Pub. Date: Dec. 2, 2021

(54) THREE-DIMENSIONAL WAVE DEVICE FOR CIRCULATING ENERGY AND BLOOD

(71) Applicant: Ki Young SHIN, Namyangju-si (KR)

(72) Inventor: Ki Young SHIN, Namyangju-si (KR)

(21) Appl. No.: 17/278,125

(22) PCT Filed: Aug. 30, 2019
(86) PCT No.: PCT/KR2019/011156

§ 371 Date: Mar. 19, 2021

(30) Foreign Application Priority Data
Sep. 20, 2018 (KR) 10-2018-0112797

(51) Int. Cl. A61H 23/02

(52) U.S. Cl. CPC A61H 23/0254; A61H 2201/169; A61H 2201/0149; A61H 2201/0142

(57) ABSTRACT

Provided is a three-dimensional wave device for circulating energy and blood. The wave device prevents noise caused by collision of a plate made of metal, a vibration motor, and fastening members used to connect the plate and the vibration motor and addresses a problem in which, when the three-dimensional wave device for circulating energy and blood is applied to products such as beds or chairs, the usage of the products is restricted in a multi-unit dwelling or apartment due to noise.

### TECHNICAL FIELD

The present disclosure relates to a three-dimensional wave device for circulating energy and blood that is applied to products such as beds or chairs, and more particularly, to a three-dimensional wave device for circulating energy and blood that is capable of, in addition to being applied to the products to provide massage and therapy functions, preventing noise caused by wave generation when a wave is generated to promote energy and blood circulation and weight loss.

### BACKGROUND ART

Generally, a vibration mechanism is applied to a bed or chair to apply vibration massage to the entire human body, and in this way, health is promoted and pain is relived.

In general, such a conventional vibration mechanism includes a vibrator body in which a motor is installed, an eccentric shaft which passes through the vibrator body and receives a rotational force from the motor to eccentrically rotate, a vibrating plate coupled to an upper end of the eccentric shaft to vibrate according to rotation of the eccentric shaft, and a mat placed on the vibrating plate.

That is, the conventional vibration mechanism performs a massage function as vibration due to high-speed rotation and dynamic imbalance when the eccentric shaft is rotated due to driving of the motor causes the vibrating plate to vibrate.

However, the conventional vibration mechanism has problems in that, in addition to cracks and damage to the eccentric shaft due to vibration of the eccentric shaft, the frequency of use is reduced due to generating a very loud noise, and the noise makes it difficult to use the conventional vibration mechanism in a multi-unit dwelling or apartment.

Meanwhile, conventionally, in order to transmit vibration to an upper pad without using an eccentric shaft to generate vibration, a vibration motor and a driving shaft and a bearing thereof are coupled to metal plates and a cushioning member made of rubber is coupled in between the metal plates. However, heavy noise is inevitably generated due to collision between a contact portion between the plates made of metal and the vibration motor and the driving shaft and bearing thereof and screws, washers, and the like which are fastening members configured to couple the plates made of metal and the cushioning member.

### DISCLOSURE

### Technical Problem

The present disclosure is directed to providing a three-dimensional wave device for circulating energy and blood that prevents noise caused by metal materials and collision of the metal materials.

### Technical Solution

One aspect of the present disclosure provides a three-dimensional wave device for circulating energy and blood, the three-dimensional wave device including a first plate, a second plate, and a third plate that constitute three stages and are made of a rigid metal material, a hard first rubber column that is vertically coupled between the first plate and the second plate, a hard second rubber column that is vertically coupled between the second plate and the third plate, which has a fixing ring made of a rigid metal material coupled to a center of an upper surface thereof, and a vibration motor that has a driving shaft coupled to a center of a bottom surface of the second plate, wherein a bearing coupled to the driving shaft is disposed at an inner center of the fixing ring, a hard rubber cushioning ring configured to fix the bearing and absorb vibration is fitted and coupled between the bearing and the fixing ring, and hard rubber surface layers configured to absorb vibration occurring due to driving of the vibration motor are formed on surfaces of the first to third plates that constitute three stages.

Also, at least one or more first insert pins may be formed to protrude from an upper surface of the rubber surface layer that covers the first plate, a first insert groove into which the first insert pin is inserted may be formed in a lower surface of the first rubber column, and a first core configured to reinforce strength may be formed inside the first insert pin.

Also, a connecting frame that has a circular mounting part and a bent cushioning part may be formed on the second plate, a fastening screw may be formed to protrude from an upper surface of the first rubber column, and the circular mounting part may be fastened to the fastening screw as a washer is mounted thereon.

Also, at least one or more second insert pins may be formed to protrude from an upper surface of the rubber surface layer that covers the second plate, a second insert groove into which the second insert pin is inserted may be formed in a lower surface of the second rubber column, and a second core configured to reinforce strength may be formed inside the second insert pin.

Also, at least one or more third insert pins may be formed to protrude from a lower surface of the rubber surface layer that covers the third plate, a third insert groove into which the third insert pin is inserted may be formed in an upper surface of the second rubber column, and a third core configured to reinforce strength may be formed inside the third insert pin.

Also, at least one or more first insert nuts may be formed on the first plate covered by the rubber surface layer, a first insert screw configured to be inserted into and fastened to the first insert nut may be formed to protrude from the lower surface of the first rubber column, and an eleventh core configured to reinforce strength may be formed inside the first insert screw.

Also, at least one or more second insert nuts may be formed on the second plate covered by the rubber surface layer, a second insert screw configured to be inserted into and fastened to the second insert nut may be formed to protrude from the lower surface of the second rubber column, and a twelfth core configured to reinforce strength may be formed inside the second insert screw.

Also, at least one or more third insert nuts may be formed on the third plate covered by the rubber surface layer, a third insert screw configured to be inserted into and fastened to the third insert nut may be formed on the upper surface of the second rubber column, and a thirteenth core configured to reinforce strength may be formed inside the third insert screw.

Also, a three-dimensional wave caused by the driving of the vibration motor may be transmitted to the rubber cushioning ring through the bearing coupled to the driving shaft and may be, through the fixing ring being in contact with the rubber cushioning ring, spread to a panel in contact with the fixing ring.

Also, the panel may be any one of a mattress, a chair, and a sofa backrest.

Also, all of the first rubber column, the second rubber column, the rubber cushioning ring, and the rubber surface layer may be made of rubber or a resin material in which rubber is synthesized.

Also, all of the first insert pin, the second insert pin, the third insert pin, the first insert nut, the first insert screw, the second insert nut, the second insert screw, the third insert nut, and the third insert screw may be made of rubber or a resin in which rubber is synthesized.

Also, all of the connecting frame, the first core, the second core, the third core, the eleventh core, the twelfth core, and the thirteenth core may be made of a metal material.

Also, the driving shaft may include a cylindrical first shaft part coupled to one end of the vibration motor and a semicircular second shaft part that extends from an upper end of the first shaft part and is coupled to the bearing to generate an eccentric rotational force.

Also, the bearing may have a circular coupler to which the cylindrical first shaft part is fitted and coupled.

Also, the bearing may have a semicircular coupler to which the semicircular second shaft part is fitted and coupled.

### Advantageous Effects

The present disclosure prevents a noise caused by collision of a plate made of metal, a vibration motor, and fastening members used to connect the plate and the vibration motor. In this way, it is possible to address a problem in which, when a three-dimensional wave device for circulating energy and blood is applied to products such as beds or chairs, the usage of the products is restricted in a multi-unit dwelling or apartment due to noise.

The advantageous effects of the present disclosure are not limited to those mentioned above, and other unmentioned advantageous effects should be clearly understood by those of ordinary skill in the art from the claims below.

### DESCRIPTION OF DRAWINGS

FIG. 1 is a combined perspective view illustrating a structure of a three-dimensional wave device for circulating energy and blood according to a first embodiment of the present disclosure.

FIG. 2 is an exploded perspective view illustrating the structure of the three-dimensional wave device for circulating energy and blood according to the first embodiment of the present disclosure.

FIG. 3 is a combined cross-sectional schematic diagram relating to FIG. 1 according to the first embodiment of the present disclosure.

FIG. 4 is an exploded cross-sectional schematic diagram relating to FIG. 1 according to the first embodiment of the present disclosure.

FIG. 5 is a cross-sectional schematic diagram illustrating a state in which the three-dimensional wave device for circulating energy and blood is applied to a product according to the first embodiment of the present disclosure.

FIG. 6 is a combined perspective view illustrating a structure of a three-dimensional wave device for circulating energy and blood according to a second embodiment of the present disclosure.

FIG. 7 is an exploded perspective view illustrating the structure of the three-dimensional wave device for circulating energy and blood according to the second embodiment of the present disclosure.

FIG. 8 is a combined cross-sectional schematic diagram relating to FIG. 6 according to the second embodiment of the present disclosure.

FIG. 9 is an exploded cross-sectional schematic diagram relating to FIG. 6 according to the second embodiment of the present disclosure.

FIG. 10 is a cross-sectional schematic diagram illustrating another embodiment relating to a driving shaft.

### BEST MODE OF THE INVENTION

Hereinafter, embodiments of the present disclosure will be described with reference to the accompanying drawings.

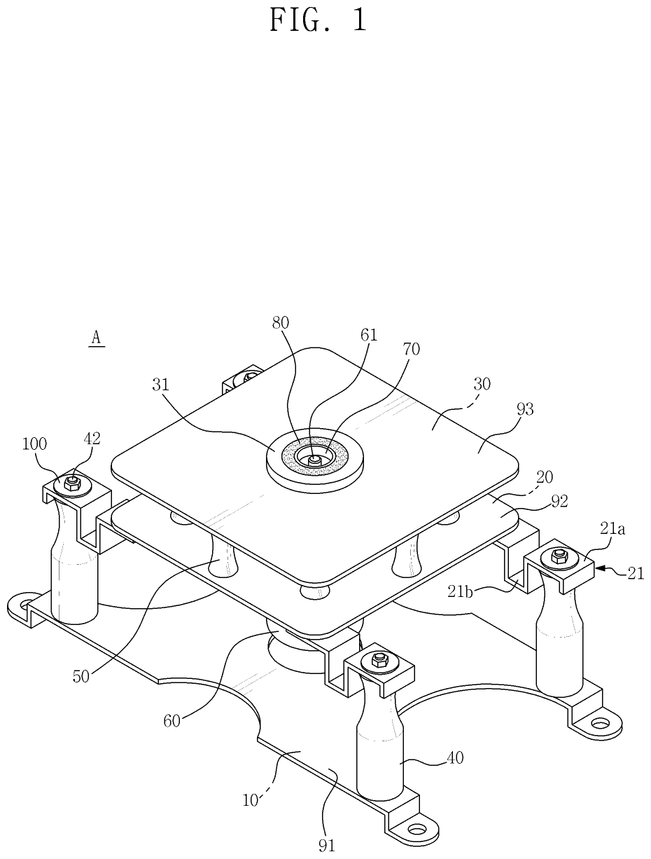

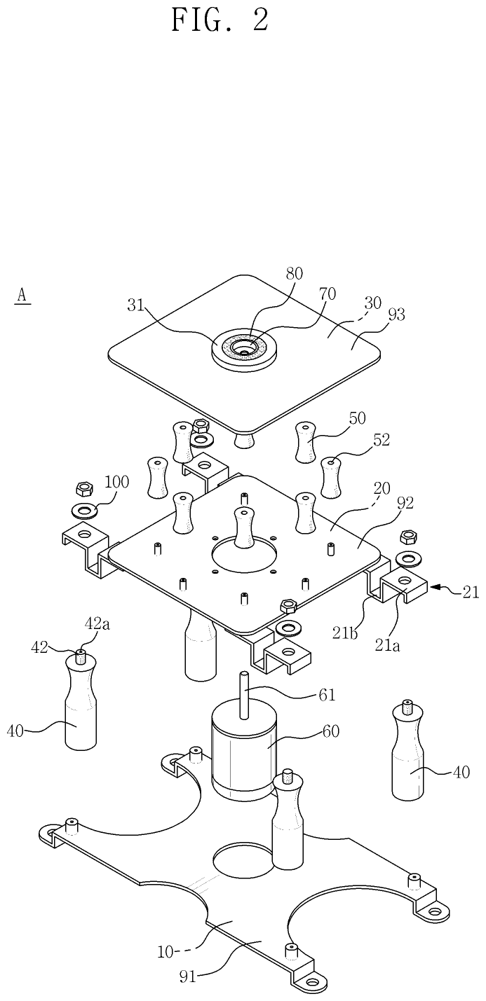

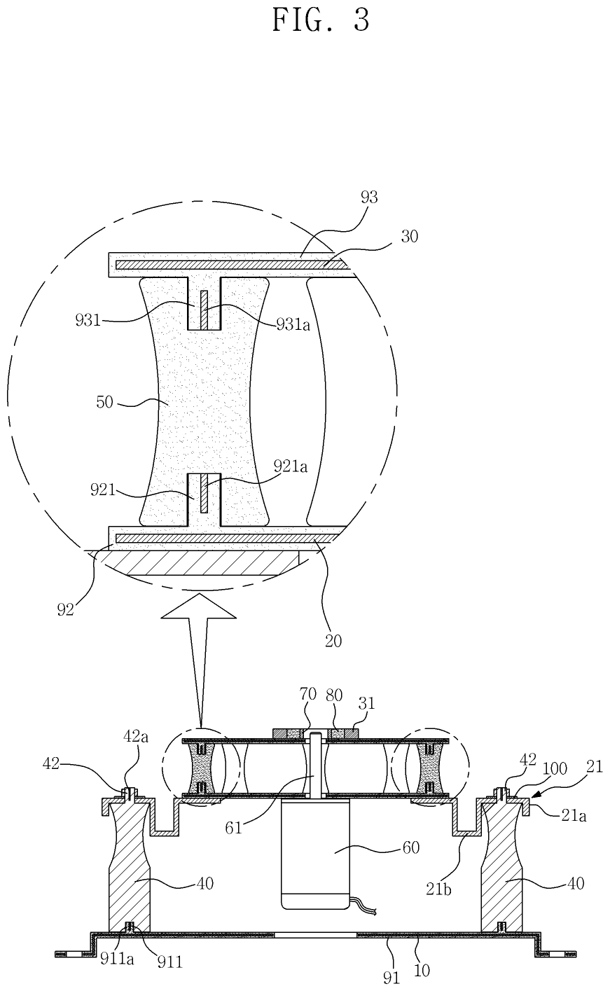

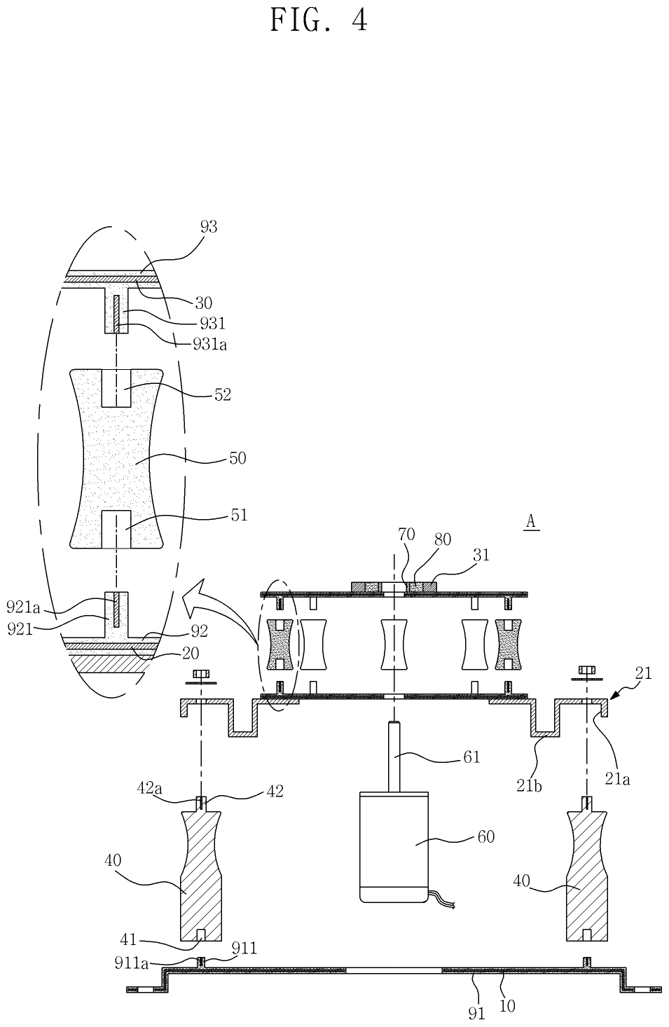

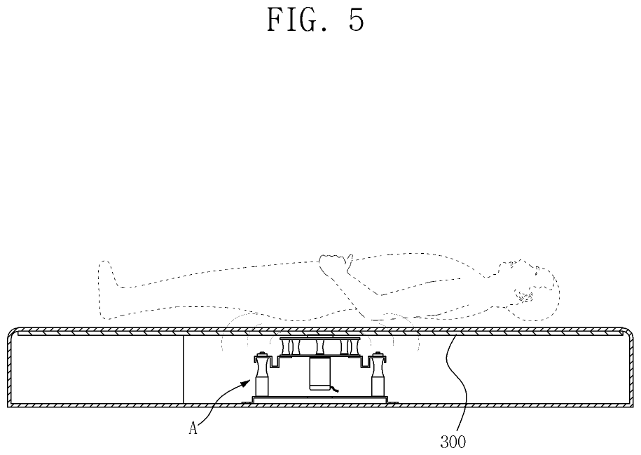

FIG. 1 is a combined perspective view illustrating a structure of a three-dimensional wave device for circulating energy and blood according to a first embodiment of the present disclosure, FIG. 2 is an exploded perspective view illustrating the structure of the three-dimensional wave device for circulating energy and blood according to the first embodiment of the present disclosure, FIG. 3 is a combined cross-sectional schematic diagram relating to FIG. 1 according to the first embodiment of the present disclosure, FIG. 4 is an exploded cross-sectional schematic diagram relating to FIG. 1 according to the first embodiment of the present disclosure, and FIG. 5 is a cross-sectional schematic diagram illustrating a state in which the three-dimensional wave device for circulating energy and blood is applied to a product according to the first embodiment of the present disclosure.

Referring to FIGS. 1 to 5, a three-dimensional wave device A for energy and blood circulation according to the embodiment of the present disclosure includes first to third plates 10, 20, and 30, first and second rubber columns 40 and 50, a vibration motor 60, a bearing 70, a rubber cushioning ring 80, and first to third rubber surface layers 91, 92, and 93.

The first to third plates 10, 20, and 30 are made of rigid metal plates in order to, when the three-dimensional wave device A for energy and blood circulation is accommodated in a panel 300 which is a mattress, a chair, a sofa backrest, or the like, prevent the three-dimensional wave device A for energy and blood circulation from being deformed due to a user load being applied from the outside of the panel 300.

Here, one end of a connecting frame 21, which is made of metal and has a circular mounting part 21a and a bent cushioning part 21b, may be coupled to the second plate 20 by welding or using fastening members such as a bolt and a nut (not illustrated). However, preferably, the one end of the connecting frame 21 may be bonded and coupled to the second plate 20 by welding because welding is advantageous in terms of preventing noise.

Accordingly, while the second and third plates 20 and 30 located at the middle and the uppermost end, respectively, have the same shape, the first plate 10, which is located at the lowermost end and requires a support force, has separate extending parts (not denoted by reference numerals) formed on edge portions thereof unlike the second and third plates 20 and 30, and the extending parts may be coupled and fixed to the inside of the panel 300 through fastening members (e.g., bolt, nut).

Meanwhile, although not denoted by reference numerals in the drawings, a circular hole may be formed in a central portion of each of the first to third plates 10, 20, and 30, and when the vibration motor 60 is being coupled to a lower surface of the second plate 20, a driving shaft 61 of the vibration motor 60 may pass through the circular holes formed in the second and third plates 20 and 30.

The first rubber column 40 is a hard structure made of rubber or a resin material in which rubber is synthesized. The first rubber column 40 may be vertically coupled between the first plate 10 and the second plate 20.

Here, a first insert groove 41 into which a first insert pin 911, which will be described below, is inserted may be formed in a lower surface of the first rubber column 40.

That is, the first rubber column 40 is coupled between the first and second plates 10 and 20 so that the first and second plates 10 and 20 constitute a vertically stacked structure while being spaced a predetermined distance apart. The lower surface of the first rubber column 40 is coupled to the first plate 10 using the first insert groove 41, and an upper surface of the first rubber column 40 is coupled to the connecting frame 21, which is coupled to the second plate 20, through a fastening member (e.g., nut). In this way, vibrational noise that occurs due to driving of the vibration motor 60 coupled to the second plate 20 may be absorbed.

Here, a fastening screw 42 is formed to protrude from the upper surface of the first rubber column 40, and a washer 100 is mounted on the circular mounting part 21a which will be described below. In this way, fastening of the fastening screw 42 is possible.

The second rubber column 50 is a hard structure made of rubber or a resin material in which rubber is synthesized. The second rubber column 50 may be vertically coupled between the second plate 20 and the third plate 30 which has a fixing ring 31 made of a rigid metal material coupled to the center of an upper surface thereof.

Accordingly, a second insert groove 51 into which a second insert pin 921, which will be described below, is inserted may be formed in a lower surface of the second rubber column 50, and a third insert groove 52 into which a third insert pin 931, which will be described below, is inserted may be formed in an upper surface of the second rubber column 50.

The vibration motor 60 has the driving shaft 61 coupled to the center of a bottom surface of the second plate 20. A three-dimensional wave caused by the driving of the vibration motor 60 may be transmitted to the rubber cushioning ring 80 through the bearing 70 coupled to the driving shaft 61 and may be, through the fixing ring 31 being in contact with the rubber cushioning ring 80, spread to the panel 300 in contact with the fixing ring 31. The panel 300 may be any one of a mattress, a chair, and a sofa backrest.

The rubber cushioning ring 80 is a hard structure made of rubber or a resin material in which rubber is synthesized. The rubber cushioning ring 80 is fitted and coupled to an inner center of the fixing ring 31 and is configured to, when the bearing 70 coupled to the driving shaft 61 is disposed, fix the bearing 70 and absorb vibration between the bearing 70 and the fixing ring 31.

The first to third rubber surface layers 91, 92, and 93 are hard structures made of rubber or a resin material in which rubber is synthesized. The first to third rubber surface layers 91, 92, and 93 are respectively formed on surfaces of the first to third plates 10, 20, and 30, which constitute three stages, to absorb vibration occurring due to driving of the vibration motor 60.

The first rubber surface layer 91 is made to cover the first plate 10 through a molding task. At least one or more first insert pins 911 are formed to protrude from an upper surface of the first rubber surface layer 91, and a first core 911a that is made of metal and configured to reinforce strength is formed inside the first insert pin 911.

Accordingly, since the first insert pin 911 may be inserted into the first insert groove 41 formed in the lower surface of the first rubber column 40, vibration caused by the driving of the vibration motor 60 may be absorbed.

The second rubber surface layer 92 is made to cover the second plate 20 through a molding task. At least one or more second insert pins 921 are formed to protrude from an upper surface of the second rubber surface layer 92, and a second core 921a that is made of metal and configured to reinforce strength is formed inside the second insert pin 921.

Accordingly, since the second insert pin 921 may be inserted into the second insert groove 51 formed in the lower surface of the second rubber column 50, vibration caused by the driving of the vibration motor 60 may be absorbed.

The third rubber surface layer 93 is made to cover the third plate 30 through a molding task. At least one or more third insert pins 931 are formed to protrude from a lower surface of the third rubber surface layer 93, and a third core 931a that is configured to reinforce strength is formed inside the third insert pin 931.

Accordingly, since the third insert pin 931 may be inserted into the third insert groove 52 formed in the upper surface of the second rubber column 50, vibration caused by the driving of the vibration motor 60 may be absorbed.

Here, although not illustrated in the drawings, in the molding task in which the first to third rubber surface layers 91, 92, and 93 are respectively formed on the surfaces of the first to third plates 10, 20, and 30, the plates 10, 20, and 30 may be put into a lower mold and then, in a state in which the lower mold is covered by an upper mold, rubber or a resin material including rubber may be injected into the upper and lower molds to integrally form the first to third rubber surface layers 91, 92, and 93 on the surfaces of the first to third plates 10, 20, and 30, respectively. Forming the insert pins 911, 921, and 931 to protrude from the upper surface or lower surface of the first to third rubber surface layers 91, 92, and 93 is made possible by forming a molding groove, which is for forming the insert pins 911, 921, and 931, in the upper mold.

In this way, in the three-dimensional wave device A for energy and blood circulation according to the first embodiment of the present disclosure, as illustrated in FIGS. 1 to 5, in the state in which the first to third plates 10, 20, and 30 made of metal are vertically stacked so as to be spaced a predetermined distance apart using the first and second rubber columns 40 and 50, the vibration motor 60 is coupled to the second plate 20, the driving shaft 61 of the vibration motor 60 is coupled to the bearing 70 on an upper surface of the third plate 30, and then the rubber cushioning ring 80 is fitted and coupled between the bearing 70 and the fixing ring 31.

Here, since the first to third rubber surface layers 91, 92, and 93 are formed on the surfaces of the first to third plates 10, 20, and 30, respectively, the first insert pin 911 is formed on the upper surface of the first rubber surface layer 91, the second insert pin 921 is formed on the upper surface of the second rubber surface layer 92, the third insert pin 931 is formed on the lower surface of the third rubber surface layer 93, and the first to third cores 911a, 921a, and 931a are formed inside the first to third insert pins 911, 921, and 931, respectively, the first insert pin 911 is inserted into the first insert groove 41 formed in the lower surface of the first rubber column 40, the second insert pin 921 is inserted into the second insert groove 51 formed in the lower surface of the second rubber column 50, and the third insert pin 931 is inserted into the third insert groove 52 formed in the upper surface of the second rubber column 50.

Here, the upper surface of the first rubber column 40 is fastened to the connecting frame 21, which extends from the second plate 20, using a fastening member.

Therefore, the vibration motor 60 is driven in a state in which the three-dimensional wave device A for energy and blood circulation that is assembled as described above is applied to the inside of the panel 300 which may be any one of a mattress, a chair, and a sofa backrest.

Then, a driving force of the vibration motor 60 is transmitted to the third plate 30, which is at the uppermost end, through the driving shaft 61, and when a user lies down or leans on the panel 300, energy waves caused by the driving force are transmitted to the user's body that is pressed against the panel 300 so that, not only is a massage function provided to the user's body, but also energy and blood circulation and weight loss are promoted. In the case of children, the growth plate may be stimulated to promote growth.

Here, when the driving force of the vibration motor 60 is transmitted to the third plate 30, which is at the uppermost end, as described above, since, not only the third plate 30 and the second rubber column 50, but also the second rubber column 50 and the second plate 20, the second plate 20 and the first rubber column 40, and the first rubber column 40 and the first plate 10, which is at the lowermost end, are in contact with each other via rubber or a resin material including rubber, noise generation when the energy waves caused by the driving force of the vibration motor 60 are transmitted to the panel 300 may be minimized.

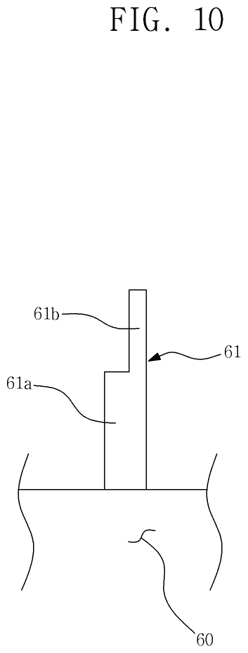

Meanwhile, although the driving shaft 61 having a circular shape has been described above according to the first embodiment of the present disclosure, as illustrated in FIG. 10, the driving shaft 61 may be configured to be divided into a cylindrical first shaft part 61a coupled to one end of the vibration motor 60 and a semicircular second shaft part 61b that extends from an upper end of the first shaft part 61a and is coupled to the bearing 70 to generate an eccentric rotational force.

Accordingly, when the driving force of the vibration motor 60 is transmitted to the second shaft part 61b, although more energy waves may be generated on the third plate 30, noise due to the generation of energy waves may be minimized as described above.

### Modes of the Invention

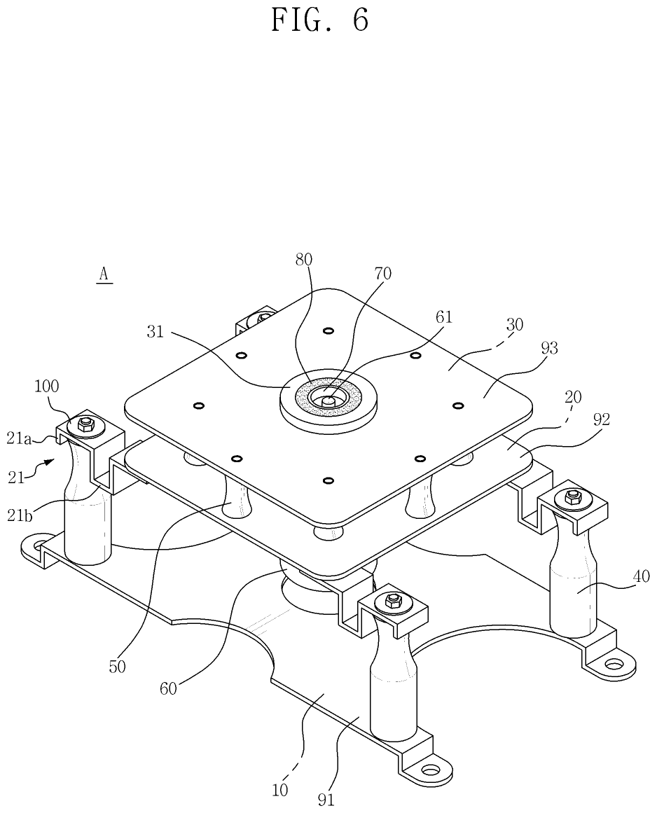

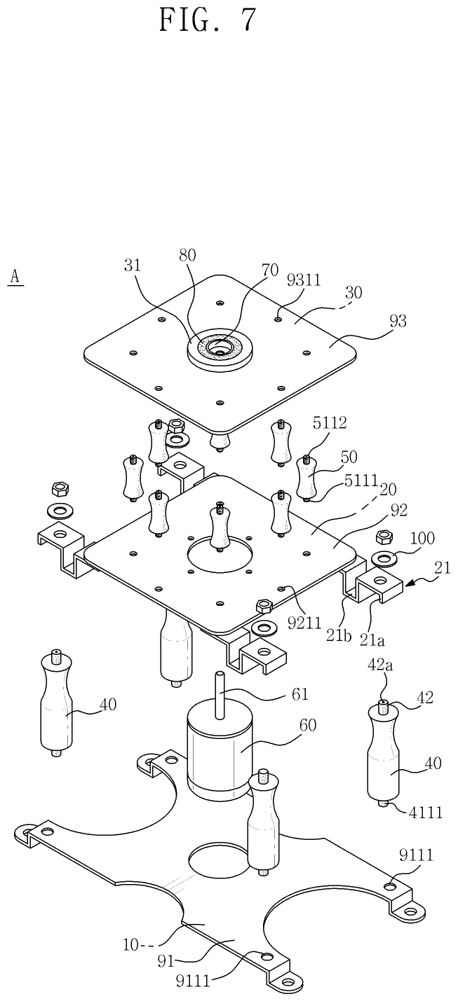

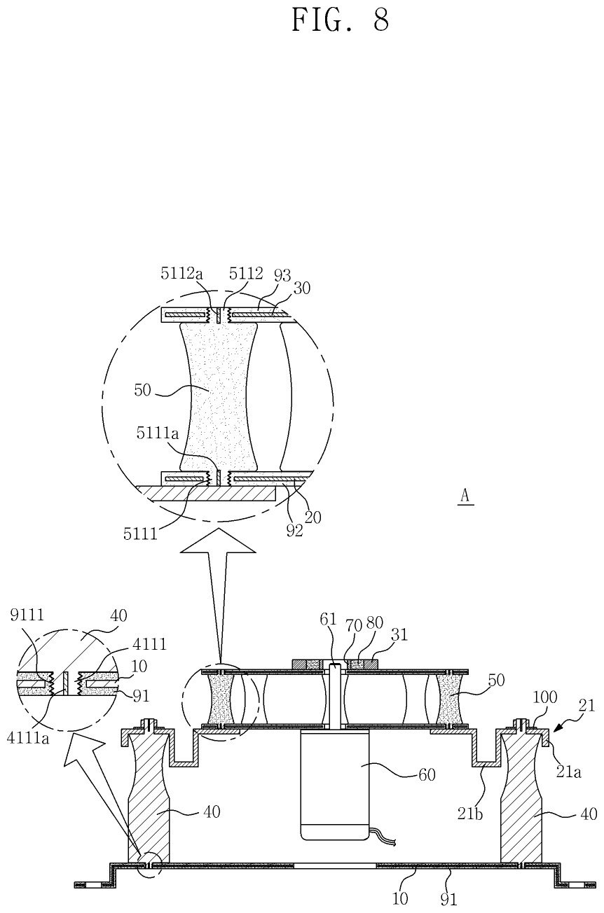

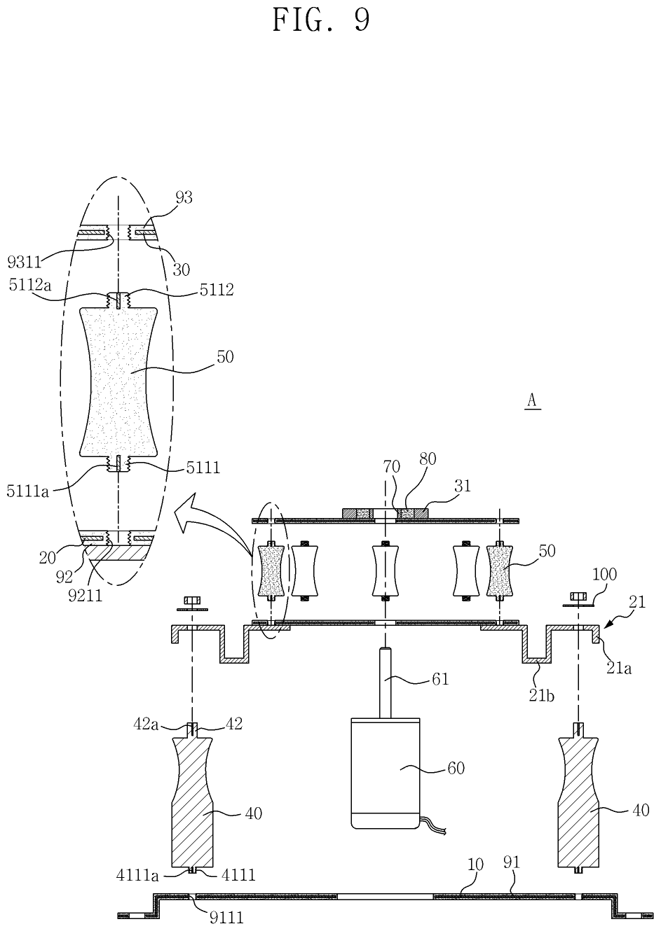

FIGS. 6 to 9 relate to a second embodiment of the present disclosure. According to the second embodiment, at least one or more first insert nuts 9111 are formed on the first plate 10 covered by the rubber surface layer 91, a first insert screw 4111 inserted into and fastened to the first insert nut 9111 is formed to protrude from the lower surface of the first rubber column 40, and an eleventh core 4111a configured to reinforce strength is formed inside the first insert screw 4111.

Also, at least one or more second insert nuts 9211 are formed on the second plate 20 covered by the rubber surface layer 92, a second insert screw 5111 inserted into and fastened to the second insert nut 9211 is formed to protrude from the lower surface of the second rubber column 50, and a twelfth core 5111a configured to reinforce strength is formed inside the second insert screw 5111.

In addition, at least one or more third insert nuts 9311 are formed on the third plate 30 covered by the rubber surface layer 93, a third insert screw 5112 inserted into and fastened to the third insert nut 9311 is formed on the upper surface of the second rubber column 50, and a thirteenth core 5112a configured to reinforce strength is formed inside the third insert screw 5112.

That is, according to the second embodiment of the present disclosure, although the first to third plates 10, 20, and 30 and the first and second rubber columns 40 and 50 are coupled using a fastening force between an insert nut and an insert screw, the coupling portions are configured to be in contact with rubber or a resin material including rubber, and accordingly, noise generated during driving of the vibration motor 60 may be minimized.

The technical idea relating to the three-dimensional wave device A for energy and blood circulation of the present disclosure has been described above with reference to the accompanying drawings, but the above description is only intended to exemplarily describe the best embodiments of the present disclosure and is not intended to limit the present disclosure.

Therefore, the present disclosure is not limited to specific preferred embodiments described above, and of course, those of ordinary skill in the art to which the disclosure pertains may modify and embody the present disclosure in various other ways without departing from the gist of the present disclosure, and such changes fall within the scope of the claims below.

### INDUSTRIAL APPLICABILITY

The three-dimensional wave device A for energy and blood circulation according to the first and second embodiments of the present disclosure can minimize noise due to collision of metal materials at each coupling portion when waves are generated to provide massage and therapy functions and to promote energy and blood circulation and weight loss. Accordingly, it is possible to address a problem in which, when the three-dimensional wave device A for energy and blood circulation is applied to products such as beds or chairs, the usage of the products is restricted in a multi-unit dwelling or apartment due to noise.

1. A three-dimensional wave device for circulating energy and blood, the three-dimensional wave device comprising:
a first plate, a second plate, and a third plate that constitute three stages and are made of a rigid metal material;
a hard first rubber column that is vertically coupled between the first plate and the second plate;
a hard second rubber column that is vertically coupled between the second plate and the third plate, which has a fixing ring made of a rigid metal material coupled to a center of an upper surface thereof; and
a vibration motor that has a driving shaft coupled to a center of a bottom surface of the second plate,
wherein a bearing coupled to the driving shaft is disposed at an inner center of the fixing ring, and a hard rubber cushioning ring configured to fix the bearing and absorb vibration is fitted and coupled between the bearing and the fixing ring; and
hard rubber surface layers configured to absorb vibration occurring due to driving of the vibration motor are formed on surfaces of the first to third plates that constitute three stages.

2. The three-dimensional wave device of claim 1, wherein:
at least one or more first insert pins are formed to protrude from an upper surface of the rubber surface layer that covers the first plate;
a first insert groove into which the first insert pin is inserted is formed in a lower surface of the first rubber column; and
a first core configured to reinforce strength is formed inside the first insert pin.

3. The three-dimensional wave device of claim 2, wherein:
a connecting frame that has a circular mounting part and a bent cushioning part is formed on the second plate;
a fastening screw is formed to protrude from an upper surface of the first rubber column; and
the circular mounting part is fastened to the fastening screw as a washer is mounted thereon.

4. The three-dimensional wave device of claim 3, wherein:
at least one or more second insert pins are formed to protrude from an upper surface of the rubber surface layer that covers the second plate;
a second insert groove into which the second insert pin is inserted is formed in a lower surface of the second rubber column; and
a second core configured to reinforce strength is formed inside the second insert pin.

5. The three-dimensional wave device of claim 4, wherein:
at least one or more third insert pins are formed to protrude from a lower surface of the rubber surface layer that covers the third plate;
a third insert groove into which the third insert pin is inserted is formed in an upper surface of the second rubber column; and
a third core configured to reinforce strength is formed inside the third insert pin.

6. The three-dimensional wave device of claim 3, wherein:
at least one or more first insert nuts are formed on the first plate covered by the rubber surface layer;
a first insert screw configured to be inserted into and fastened to the first insert nut is formed to protrude from the lower surface of the first rubber column; and
an eleventh core configured to reinforce strength is formed inside the first insert screw.

7. The three-dimensional wave device of claim 6, wherein:
at least one or more second insert nuts are formed on the second plate covered by the rubber surface layer;
a second insert screw configured to be inserted into and fastened to the second insert nut is formed to protrude from the lower surface of the second rubber column; and
a twelfth core configured to reinforce strength is formed inside the second insert screw.

8. The three-dimensional wave device of claim 7, wherein:
at least one or more third insert nuts are formed on the third plate covered by the rubber surface layer;
a third insert screw configured to be inserted into and fastened to the third insert nut is formed on the upper surface of the second rubber column; and
a thirteenth core configured to reinforce strength is formed inside the third insert screw.

9. The three-dimensional wave device of claim 1, wherein a three-dimensional wave caused by the driving of the vibration motor is transmitted to the rubber cushioning ring through the bearing coupled to the driving shaft and is, through the fixing ring being in contact with the rubber cushioning ring, spread to a panel in contact with the fixing ring.

10. The three-dimensional wave device of claim 9, wherein the panel is any one of a mattress, a chair, and a sofa backrest.

11. The three-dimensional wave device of claim 5, wherein all of the first rubber column, the second rubber column, the rubber cushioning ring, the rubber surface layer, the first insert pin, the second insert pin, and the third insert pin are made of rubber or a resin material in which rubber is synthesized.

12. The three-dimensional wave device of claim 8, wherein all of the first rubber column, the second rubber column, the rubber cushioning ring, the rubber surface layer, the first to third insert nuts, and the first to third insert screws are made of rubber or a resin material in which rubber is synthesized.

13. The three-dimensional wave device of claim 5, wherein all of the connecting frame, the first core, the second core, and the third core are made of a metal material.

14. The three-dimensional wave device of claim 8, wherein all of the connecting frame, the eleventh core, the twelfth core, and the thirteenth core are made of a metal material.

15. The three-dimensional wave device of claim 1, wherein the driving shaft includes a cylindrical first shaft part coupled to one end of the vibration motor and a semicircular second shaft part that extends from an upper end of the first shaft part and is coupled to the bearing to generate an eccentric rotational force.

16. The three-dimensional wave device of claim 15, wherein the bearing has a circular coupler to which the cylindrical first shaft part is fitted and coupled.

17. The three-dimensional wave device of claim 15, wherein the bearing has a semicircular coupler to which the semicircular second shaft part is fitted and coupled.
